(19) United States
(12) Patent Application Publication
(10) Pub. No.: US 2013/0138870 A1
(43) Pub. Date: May 30, 2013

(54) MEMORY SYSTEM, DATA STORAGE DEVICE, MEMORY CARD, AND SSD INCLUDING WEAR LEVEL CONTROL LOGIC

(71) Applicants: SANGYONG YOON, SEOUL (KR); CHULHO LEE, SUWON-SI (KR); KYEHYUN KYUNG, YONGIN-SI (KR); JAEYONG JEONG, YONGIN-SI (KR)

(72) Inventors: SANGYONG YOON, SEOUL (KR); CHULHO LEE, SUWON-SI (KR); KYEHYUN KYUNG, YONGIN-SI (KR); JAEYONG JEONG, YONGIN-SI (KR)

(73) Assignee: SAMSUNG ELECTRONICS CO., LTD., SUWON-SI (KR)

(21) Appl. No.: 13/604,780

(22) Filed: Sep. 6, 2012

(30) Foreign Application Priority Data
Nov. 30, 2011 (KR) 10-2011-0127043

(51) Int. Cl. G06F 12/02

(52) U.S. Cl. 711/103; 711/E12.008

(57) ABSTRACT

Disclosed is a memory system which includes a nonvolatile memory having a user area and a buffer area; and wear level control logic managing a mode change operation in which memory blocks of the user area are partially changed into the buffer area, based on wear level information of the nonvolatile memory.

### CROSS-REFERENCE TO RELATED APPLICATIONS

A claim for priority under 35 U.S.C §119 is made to Korean Patent Application No. 10-2011-0127043 filed Nov. 30, 2011, the subject matter of which is hereby incorporated by reference.

### BACKGROUND

The inventive concept relates to nonvolatile semiconductor memory devices and memory systems incorporating same. More particularly, the inventive concept relates to nonvolatile systems capable of executing a mode change operation that redefines a boundary between defined use fields for a memory cell array in a nonvolatile memory device.

Semiconductor memory devices may be generally classified as volatile or nonvolatile. Volatile memories such as DRAM, SRAM, and the like lose stored data in the absence of applied power. In contrast, nonvolatile memories such as EEPROM, FRAM, PRAM, MRAM, flash memory, and the like are able to retained stored data in the absence of applied power. Among other types of nonvolatile memory, flash memory enjoys relatively fast data access speed, low power consumption, and dense memory cell integration density. Due to these factors, flash memory has been widely adopted for use in a variety of applications as a data storage medium.

To improve performance (e.g., the efficient management of incoming and outgoing file data), many nonvolatile memory systems define one portion of a constituent memory cell array as a “buffer area” that essentially serves as a cache memory for another portion of the memory cell array designated as a “user area”. Thus, incoming data will pass through the buffer area during a program operation before being stored in the user area, and outgoing data will similarly pass through the buffer area during a read operation as it is read from the user area. The use of a buffer area in conjunction with a user area reduces the number of merge operations and/or block erase operations that would otherwise be routinely performed during operation of the nonvolatile memory system. Further, the use of a buffer area in conjunction with the user are reduces the use of a SRAM within a corresponding memory controller.

Unfortunately, the cache use of a defined buffer area of a nonvolatile memory cell array in conjunction with a user area raises issues of an appropriate size for the buffer area. Large blocks of file data may necessitate frequent data transfer operations between the buffer area and the user area. Such house-keeping data exchanges between the user area and buffer area tends to slow memory system performance. Further, since the buffer area is used during all program operations, the memory cell of the buffer area tend to wear much faster that memory cells in the user area.

### SUMMARY

In one embodiment, the inventive concept provides a memory system comprising; a nonvolatile memory (NVM) including multi-level memory cells (MLC), a first portion of the MLC being designated as a buffer area and operating in a first mode and a second portion of the MLC being designated as a user area and operating in a second mode different from the first mode, and a memory controller configured to program data to the NVM using on-chip buffered programming, wherein the memory controller comprises wear level control logic configured to determine wear level information for the MLC and change a boundary designating the buffer area from the user area in response to the wear level information.

In another embodiment, the inventive concept provides a memory system comprising; a nonvolatile memory (NVM) including multi-level memory cells (MLC), a first portion of the MLC being designated as a buffer area and operating in a first mode and a second portion of the MLC being designated as a user area and operating in a second mode different from the first mode, and a memory controller configured to program data to the NVM using on-chip buffered programming, and comprising an error correction code circuit (ECC) that detects and corrects bit errors in data read from the NVM and provides ECC error rate information, and wear level control logic configured to determine wear level information for the MLC in relation to the ECC error rate information and change a boundary designating the buffer area from the user area in response to the ECC error rate information.

In another embodiment, the inventive concept provides a method of operating a memory system including a nonvolatile memory (NVM) of multi-level memory cells (MLC) and a memory controller, the method comprising; upon initialization of the memory system, using the memory controller to designate a first portion of the MLC as a buffer area operating in a first mode and a second portion of the MLC as a user area operating in a second mode, programming input data to the NVM under the control of the memory controller using on-chip buffered programming that always first programs the input data to the buffer area and then moves the input data from the buffer area to the user area, and determining wear level information for the MLC and changing a boundary designating the buffer area from the user area in response to the wear level information.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a memory system according to an embodiment of the inventive concept.

FIG. 2 is a block diagram describing a mode change operation using a program-erase cycle.

FIG. 3 is a table illustrating endurance of user and buffer areas according to a program-erase cycle of a memory system in FIG. 2.

FIGS. 4A and 4B are diagrams describing a mode change operation according to a program-erase cycle of a memory system in FIG. 2.

FIG. 5 is a diagram illustrating a mapping table used to perform a mode change operation of a memory system in FIG. 2.

FIG. 6 is a block diagram describing a mode change operation using an ECC error rate.

FIGS. 7A and 7B are diagrams describing a mode change operation according to an ECC error rate of a memory system in FIG. 6.

FIG. 8 is a block diagram describing a mode change operation using an erase loop count.

FIG. 9 is a diagram describing an erase loop count illustrated in FIG. 8.

FIGS. 10A and 10B are diagrams describing a mode change operation according to an erase loop count of a memory system in FIG. 8.

FIGS. 11 and 12 are block diagrams schematically illustrating various applications of a memory system according to an embodiment of the inventive concept.

FIG. 13 is a block diagram illustrating a memory card system to which a memory system according to an embodiment of the inventive concept is applied.

FIG. 14 is a block diagram illustrating a solid state drive system in which a memory system according to the inventive concept is applied.

FIG. 15 is a block diagram schematically illustrating an SSD controller in FIG. 14.

FIG. 16 is a block diagram schematically illustrating an electronic device including a memory system according to an embodiment of the inventive concept.

FIG. 17 is a block diagram schematically illustrating a flash memory applied to the inventive concept.

FIG. 18 is a perspective view schematically illustrating a 3D structure of a memory block illustrated in FIG. 17.

FIG. 19 is a diagram schematically illustrating an equivalent circuit of a memory block illustrated in FIG. 18.

### DETAILED DESCRIPTION

Certain embodiments will now be described in some additional detail with reference to the accompanying drawings. The inventive concept may, however, be embodied in many different forms and should not be construed as being limited to only the illustrated embodiments. Rather, these embodiments are provided so that this disclosure will be thorough and complete, and will fully convey the scope of the inventive concept to those skilled in the art. Throughout the written description and drawings, like reference numbers and labels are used to denote like or similar elements and features.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

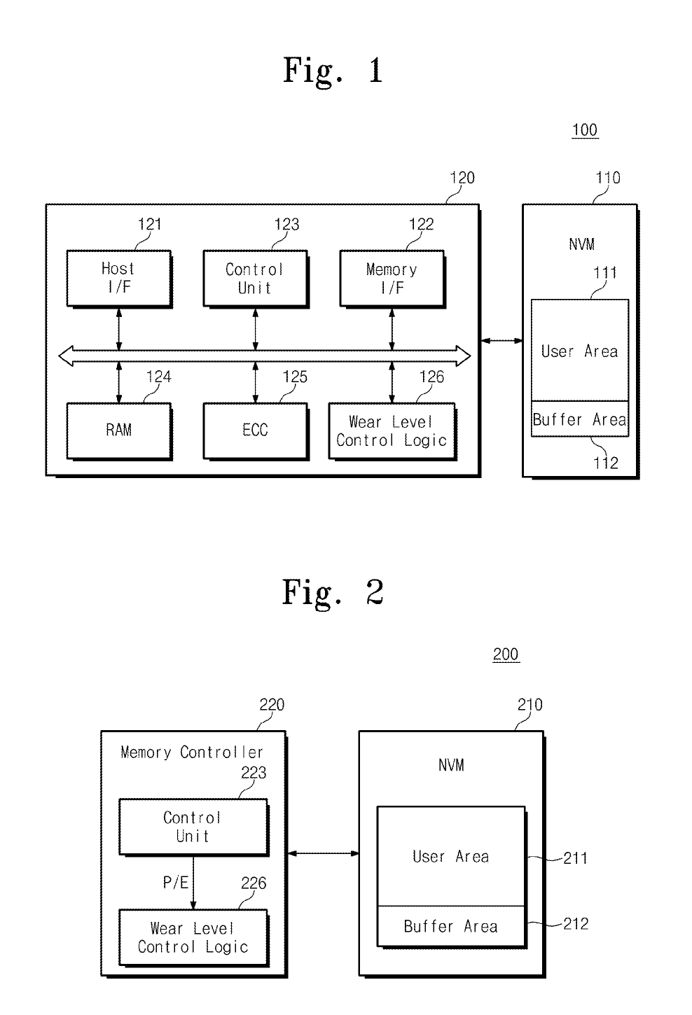

FIG. 1 is a block diagram illustrating a memory system according to an embodiment of the inventive concept. Referring to FIG. 1, a memory system 100 generally comprises a nonvolatile memory (NVM) 110 and a memory controller 120.

The NVM 110 may be controlled by the memory controller 120, and may perform operations (e.g., a read operation, a write operation, etc.) corresponding to a request of the memory controller 120. The NVM 110 includes a plurality of nonvolatile memory cells arranged in a memory cell array. Those skilled in the art will recognize that the memory cell array may be variously arranged and configured. For example, the user area 111 and the buffer area 112 may be formed of a single memory device or may be formed using multiple memory devices. However arranged or implemented, the memory cell array of the NVM 110 includes a first portion of the memory cell array designated as a user area 111 and another portion of the memory cell array designated as a buffer area 112.

The user area 111 may be used as a bulk data storage medium for various types of data. Data will be communicated to/from the user area 111 at relatively low speed. In contrast the buffer area 112 may be used to cache the data directed to/or retrieved from the user area 111 at high speed.

Hence, “high-speed nonvolatile memory” forming the buffer area 111 may be configured for use with a first mapping scheme suitable for a high-speed operations. Similarly, “low-speed nonvolatile memory” forming the user area 112 may be configured for use with a second mapping scheme suitable for a low-speed operations. For example, the user area 111 including low-speed nonvolatile memory may be managed using a block mapping scheme, while the buffer area 112 including high-speed nonvolatile memory may be managed using a page mapping scheme. As is understood by those skilled in the art, a page mapping scheme does not necessitate the use of merge operations that reduce the overall operating performance of constituent memory during (e.g.,) write operations. Thus, the use of a page mapping scheme better enables the buffer area 112 to operate at high speed. In contrast, a block mapping scheme necessitates the use of merge operations while offering other performance advantages. Yet, the slower block mapping schemes are appropriate for use with the user area 111 since it is designed to operate at relatively low speed.

The operative nature of the nonvolatile memory cells making up the user area 111 and the buffer area 112 may be different. For example, single-level, nonvolatile memory cells (SLC) configured to store a single data bit per memory cell may be used to implement the buffer area 112, while multi-level, nonvolatile memory cells (MLC) configured to store two or more data bits per memory cell may be used to implement the user area 111.

Alternately, MLC may be used to implement both the user area 111 and the buffer area 112 of the memory cell array of the NVM 110. For example, the MLC forming the user area 111 may be configured to store N-bit data per cell, while the MLC forming the buffer area 112 may be configured to store M-bit data per cell, where, M is a natural number less than N.

The memory controller 120 may be used to generally control operation of the nonvolatile memory device 110 in response to requests received from an external device (e.g., a host). The memory controller 120 of FIG. 1 includes a host interface 121, a memory interface 122, a control unit 123, a RAM, an ECC circuit 125, and wear level control logic 126.

The host interface 121 may provide an interface with the external device (e.g., a host), and the memory interface 122 may provide an interface with the nonvolatile memory device 110. The host interface 121 may be connected with the host (not shown) via one or more channels (or, ports). For example, the host interface 121 may be connected with the host via any one or all of a Parallel AT Attachment (PATA) bus and a Serial AT Attachment (SATA) bus.

The control unit 123 may control an overall operation (e.g., reading, writing, file system managing, etc.) on the nonvolatile memory 110. For example, although not shown in FIG. 1, the control unit 123 may include a CPU, a processor, an SRAM, a DMA controller, and the like. One example of the control unit 123 is disclosed, for example, in published U.S. Patent Application No. 2006-0152981, the subject matter of which is hereby incorporated by reference.

The control unit 123 may be used to manage operations controlling the transfer of data between the buffer area 112 the user area 111 and between the memory controller 120 and the NVM 110. For example, data may be “dumped” (i.e., transferred) to the buffer area 112 from the RAM 124 in response to a flush operation or a write operation.

The transfer of data to the user area 111 from the buffer area 112 may be accomplished by a number of different operations. For example, a move data operation may be executed to create available memory space in the buffer area 112 when the available memory space falls below a defined threshold (e.g., 30%). Alternately, the move data operation may be periodically executed according to a defined schedule, or the move data operation may be executed during idle time for the NVM 110.

The RAM 124 may operate under the control of the control unit 123, and may be used as a work memory, a buffer memory, a cache memory, and the like. The RAM 124 may be formed of one chip or a plurality of chips respectively corresponding to areas of the nonvolatile memory 110.

In case that the RAM 124 is used as the work memory, data processed by the control unit 123 may be temporarily stored in the RAM 124. If the RAM 124 is used as the buffer memory, it may buffer data being transferred to the nonvolatile memory 110 from the host or to the host from the nonvolatile memory 110. When the RAM 124 is used as the cache memory (hereinafter, referred to as a cache scheme), the RAM 124 better enables the use of the relatively low-speed NVM 110 in conjunction with host devices operating at high speed. Within a defined cache scheme, file data stored in the cache memory (RAM) 124 will be dumped to the buffer area 112 of the NVM 110. The control unit 123 may manage a mapping table controlling dump operations.

In the event that the NVM 110 is flash memory, the RAM 124 may be used as a drive memory implementing a Flash Translation Layer (FTL). As is understood in the art, a FTL may be used to manage merge operations for flash memory, manage one or more mapping tables, etc.

In addition to read/write commands, a host (not shown) may provide the memory system 100 with a flush cache command. In response to the flush cache command, the memory system 100 will execute a flush operation that essentially dumps file data stored in the cache memory 124 to the buffer area 112 of the NVM 110. The control unit 123 may be used to control flush operations.

The ECC circuit 125 may generate an error correction code (ECC) capable of detecting and/or correcting bit errors in the data to be stored (or data retrieved from) the NVM 110. The ECC circuit 125 may perform error correction encoding on data provided from the NVM 110 to form corresponding ECC data including parity data, for example. The parity data may be stored in the NVM 110. The ECC circuit 125 may also perform error correction decoding on output data, and may determine whether the error correction decoding is performed successfully, according to the error correction decoding result. The ECC circuit 125 may output an indication signal according to the judgment result, and may correct erroneous bits of the data using the parity data.

The ECC circuit 125 may be configured to perform error correction using Low Density Parity Check (LDPC) code, BCH code, turbo code, Reed-Solomon (RS) code, convolution code, Recursive Systematic Code (RSC), or coded modulation such as trellis-Coded Modulation (TCM), Block Coded Modulation (BCM), and the like. The ECC circuit 125 may include at least one of an error correction circuit, an error correction system, or an error correction device or all thereof.

The wear level control logic 126 may be generally used to manage wear levels for the memory cells of the NVM 110. Within this wear-level control operation, the wear level control logic 126 may cooperate with other elements to redefine the extent of the user area 111 with respect to the buffer area 112. For example, the wear level control logic 126 may change the disposition of a boundary between a first portion of the constituent memory cell array used as the buffer area 112 and another portion of the memory cell array used as the user area 111. Such a “boundary” may be defined in relation to logical addresses for the memory space of the NVM 110 and/or in relation to physical addressed for the memory space. The process of changing (or re-defining) one or more boundar(ies) designating the user area 111 from the buffer area 112 will hereafter be referred to as a “mode change operation”. In certain embodiments of the inventive concept, the “wear level” of the memory cells forming the buffer area 112 of the NVM 110, as detected by the wear level control logic 126, may be used to initiate a mode change operation. During a mode change operation, one of more memory blocks designated as being in the user area 111 are re-designated (by a corresponding boundary change) so as to subsequently operate as part of the buffer area 112. For example, the MLC in a re-designated memory block previously operated in a MLC mode may be reconfigured (upon re-designation) to operate in a SLC mode.

The wear level control logic 126 may be implemented using hardware and/or software. That is, the wear level control logic 126 may be installed by one chip or module within the memory controller 120, or may be connected via an external memory such as a floppy disk, a compact disk, or an USB memory. Meanwhile, the wear level control logic 126 can be formed using logic that is programmable by a user.

The wear level of memory cells in the NVM 110 may be checked using one or more parameters (hereinafter, referred to as a “wear-level parameter”) such as a number of program-erase cycles, a detected ECC error rate, an erase loop count, and the like. That is, the underlying wear level for the memory cells of the NVM 110 may be proportionally indicated by a corresponding number of program-erase cycles, an ECC error rate, and/or an erase loop count. Hereafter, an exemplary mode change operation for the memory system 100 of FIG. 1 using a wear-level parameter will be described in some additional detail.

FIG. 2 is a block diagram further describing a mode change operation that is executed in relation to a detected (or counted) number of program-erase cycles. Referring to FIG. 2, a memory system 200 comprises a nonvolatile memory (NVM) 210 and a memory controller 220. The NVM 210 includes a memory cell array designating a user area 211 and a buffer area 212. The MLC of the user area 211 are mode set to store/read two or more data bits per MLC during write/read operations. In contrast, the MLC of the buffer area 212 is mode set to store/read a single bit of data per MLC during write/read operations.

An allowable number of program-erase (P/E) operations for the MLC forming the memory array of the NVM 210 may be set in view of memory system performance requirements. That is, the allowable number of P/E operations will be set with an understanding of the particular P/E cycle endurance capabilities of the MLC. Of note, the P/E cycle endurance may differ between MLC mode set and SLC mode set. In general, the fewer data bits stored in a memory cell per each programming operation, the higher the P/E cycle endurance.

As previously noted, all of the data programmed in the user area 211 will first pass through the buffer area 212. Thereafter, the data is moved to the user area 211 from the buffer area 212. This approach to storing data is commonly referred to as On-chip Buffered Programming (OBP). By using OBP, the number of program-erase operations directed to the memory cells of the buffer area 212 will be elevated, and accordingly, the P/E cycle endurance for the memory cells in the buffer area 212 must be very good. In this context, the memory system 200 in FIG. 2 seeks to increase the P/E cycle endurance of the memory cells in the buffer area 212 by establishing an appropriate mode set (SLC mode verse MLC mode, for example).

Continuing to refer to FIG. 2, the memory controller 220 may include a control unit 223 and wear level control logic 226. The control unit 223 may provide the wear level control logic 226 with information on a program-erase (P/E) cycle of the NVM 210. The wear level control logic 226 may perform a mode change operation on some of memory blocks within the user area 211, based on the P/E cycle information.

For example, it is assumed that the NVM 210 includes one hundred (100) memory blocks, each memory block being formed by 3-bit MLC. Initially, it is further assumed that ninety-eight (98) memory blocks are designated as the user area 211 and mode set for operation in a 3-bit MLC mode, while the remaining two (2) memory blocks are designated as the buffer area 212 and mode set for operation in a SLC mode. However, once P/E cycles for the memory cells in the buffer area 212 exceed a given threshold, the wear level control logic 226 will cause a mode change operation to be executed during which one or more memory blocks are functionally taken from the user area 211 and added to the buffer area 212.

Conceptually, then, the boundary initially established between the 98/2 memory blocks of the NVM 210 is changed to re-designate (and accordingly mode set) one or more of the 98 memory blocks as being “new” memory blocks in the buffer area 212. For example, two (2) new memory blocks may be mode set to the SLC mode and operationally designated to function as part of the buffer memory 212, thereby establishing a new 96/4 boundary for the 100 memory blocks forming the NVM 210.

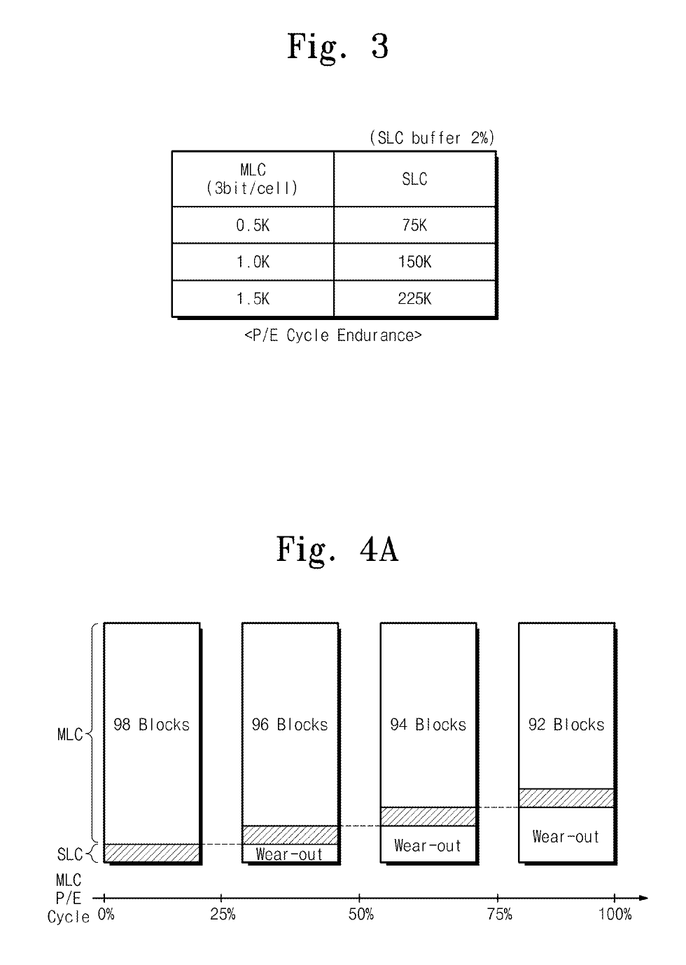

FIG. 3 is a table illustrating possible P/E endurance values for user and buffer areas assuming the foregoing memory system of FIG. 2. The respective endurance values for the memory cells in the user area 211 versus the buffer area 212, as shown in FIG. 3, may be determined in relation to different operating modes. Referring to FIG. 3, when the projected endurance for the MLC being operated in 3-bit MLC mode in the user area 211 is respectively 0.5K, 1.0K, and 1.5K, the projected endurance for MLC being operated in the SLC mode in the buffer area 212 is 75K, 150K, and 225K. Using these assumed P/E values, in order to guarantee at least 1000 P/E cycles for the memory cells in the MLC user area 211, the NVM 200 must provide 150,000 P/E cycles for the memory cells in the SLC buffer area 212. The following equation may show correlation between the endurance MLC[E] of the MLC user area 211 and the endurance SLC[E] of the SLC buffer area 212.

SLC[E]=MLC[E]×3×(M/S) (1)

In the equation 1, “M” indicates a number of MLC blocks, and “S” indicates a number of SLC blocks.

The endurance SLC[E] of the SLC buffer area 212 may increase in proportion to an increase in the endurance MLC[E] of the MLC, while it may decrease when the number of memory blocks of the SLC buffer 212 increases. The endurance SLC[E] of the SLC buffer area 212 may be larger by 10 or more times than that of the MLC user area 211. This may mean that the endurance is maintained over 90% although some used memory blocks of the MLC user area 211 are mode effectively “changed” into the SLC buffer area 212.

FIGS. 4A and 4B are conceptual diagrams further describing a mode change operation according to program-erase cycles of the memory system of FIG. 2. FIG. 4A shows a mode change operation according to a variation (%) of a P/E cycle of an MLC user area 211 of the NVM 210. FIG. 4B shows a mode change operation according to a variation (%) of a P/E cycle of an SLC buffer area 212.

Referring to FIG. 4A, at an initial stage (0%) of the P/E cycle of the MLC user area 211, the MLC user area 211 may occupy a space of about 98%, the SLC buffer area 212 may occupy a space of about 2%. That is, 98 memory blocks of 100 memory blocks in the NVM 210 may be used as a user area, and two memory blocks thereof may be used as a buffer area.

In case that the P/E cycle of the MLC user area 211 reaches about 25%, some memory blocks (e.g., two memory blocks) of the MLC user area 211 may be changed into the SLC buffer area 212. For example, it is assumed that the P/E cycle endurance of the MLC user area 211 is 1000 cycles. With this assumption, two memory blocks of the MLC user area 211 may be changed into the SLC buffer area 212 when 250 P/E cycles are performed. A memory block that was used at the SLC buffer area 212 may be treated as a worn-out memory block, that is, a bad block. A memory block changed into the SLC buffer area 212 may have the endurance corresponding to 100K or more P/E cycles.

In case that the P/E cycle of the MLC user area 211 reaches about 50%, some memory blocks of the remaining memory blocks of the MLC user area 211 may be changed into the SLC buffer area 212. For example, two memory blocks of the MLC user area 211 may be changed into the SLC buffer area 212 when 500 P/E cycles are performed. A memory block that was used at the SLC buffer area 212 may be treated as a worn-out memory block, that is, a bad block. At this time, the MLC user area 211 may include 94 memory blocks.

Likewise, if the P/E cycle of the MLC user area 211 reaches about 75%, some memory blocks of the remaining memory blocks of the MLC user area 211 may be changed into the SLC buffer area 212. For example, two memory blocks of the MLC user area 211 may be changed into the SLC buffer area 212 after 750 P/E cycles. A memory block that was used at the SLC buffer area 212 may be treated as a worn-out memory block, that is, a bad block. At this time, the MLC user area 211 may include 92 memory blocks.

Referring to FIG. 4B, at an initial stage (0%) of the P/E cycle of the SLC buffer area 212, 98 memory blocks of 100 memory blocks in the NVM 210 may be used as a user area, and two memory blocks thereof may be used as a buffer area.

In case that the P/E cycle of the SLC buffer area 212 reaches about 70%, two memory blocks of the MLC user area 211 may be changed into the SLC buffer area 212. At this time, the SLC buffer area 212 may include four memory blocks. P/E cycles of memory blocks newly changed into the SLC buffer area 212 may be larger than that of an existing memory block of the SLC buffer area 212. This may mean that the P/E cycle endurance of the SLC buffer area 212 increases overall.

If the P/E cycle of the MLC user area 211 reaches about 80%, some memory blocks of the remaining memory blocks of the MLC user area 211 may be changed into the SLC buffer area 212. At this time, a memory block that was used at the SLC buffer area 212 from the beginning may be treated as a worn-out memory block, that is, a bad block. At this time, the MLC user area 211 may include 94 memory blocks.

Likewise, in case that the P/E cycle of the MLC user area 211 reaches about 90%, some memory blocks of the remaining memory blocks of the MLC user area 211 may be changed into the SLC buffer area 212. Four memory blocks that was used at the SLC buffer area 212 may be treated as a worn-out memory block, that is, a bad block. At this time, the MLC user area 211 may include 92 memory blocks.

In FIGS. 4A and 4B, there is illustrated the case that four references are used according to a P/E cycle to change memory blocks of the user area 211 into the buffer area 212. The user area 211 may occupy a space of about 98% at the beginning, and a space occupied by the user area 211 may be gradually reduced up to about 92%. A space of the user area 211 may be reduced, while the P/E cycle endurance of the buffer area 212 may increase. Thus, the performance of the memory system 200 may be improved.

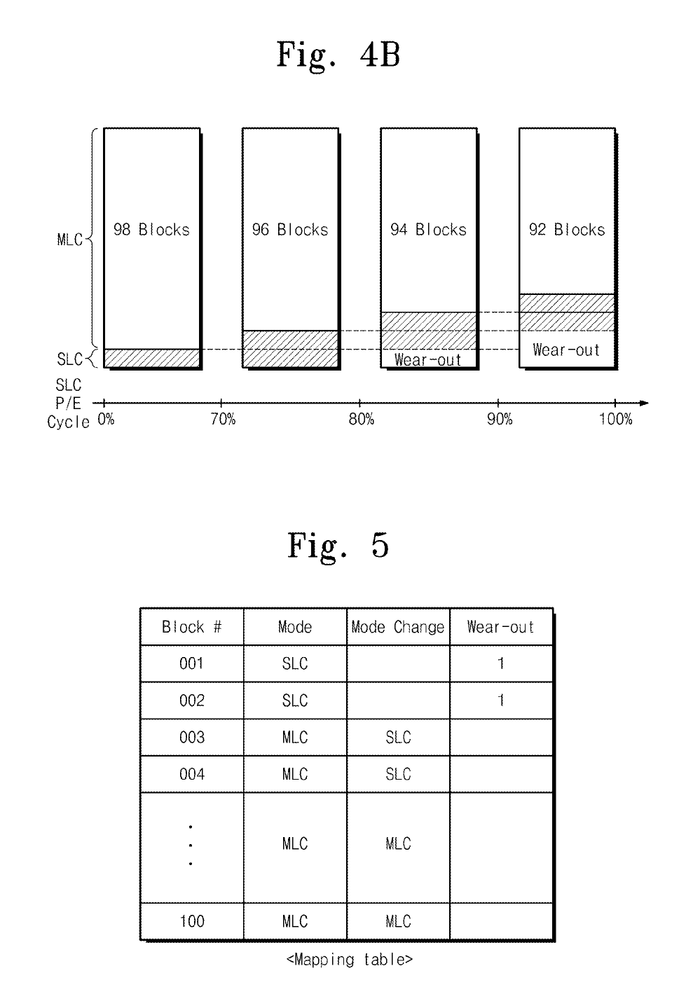

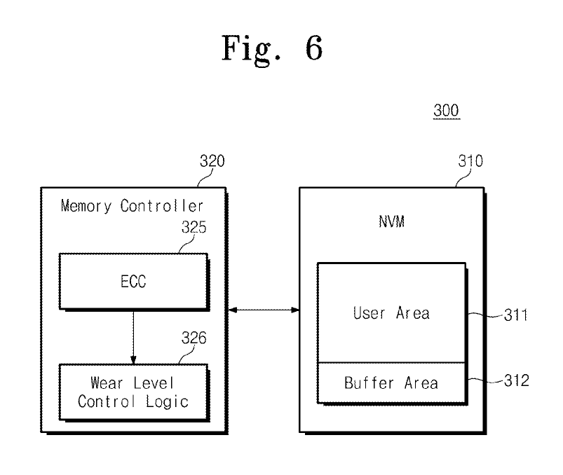

FIG. 5 is a chart illustrating a mapping table that may be used to track the results of continuing mode change operation(s) for the memory system of FIG. 2. The mapping table of FIG. 5 shows the case that a P/E cycle of an MLC user area 211 reaches about 25%.

Referring to FIG. 5, the NVM 210 includes 100 memory blocks 001 through 100. Initially, the first and second memory blocks 001 and 002 are mode set to operate in a SLC mode, and are designated as being part of the SLC buffer area 212. The remaining memory blocks 003 and 100 are mode set to operate in a MLC mode and are designated as being part of the MLC user area 211.

However, once the counted P/E cycle for the user area 211 reaches about 25%, the first and second memory blocks 001 and 002 are assumed to be well worn, and the third and fourth memory blocks 003 and 004 are changed from the user area 211 to the buffer area 212 by functionally re-designating and appropriately mode setting to the SLC mode. That is, the boundary between the user area 211 and the buffer area 212 is changed, such that the buffer area 212 now includes the third and fourth memory blocks 003 and 004.

Returning to FIG. 2, the memory system 200 is capable of executing a mode change operation whereby certain memory blocks of the user area 211 are changed into memory blocks in the buffer area 212 in accordance with changes in the program-erase (P/E) cycle information for certain memory blocks or memory cells. By use of the mode change operation, embodiments of the inventive concept are able to effectively extend the useful life of the memory cell array in the memory system 200 while also improving overall performance.

FIG. 6 is a block diagram describing a mode change operation that is predicated upon an ECC error rate instead of a P/E cycle count. Referring to FIG. 6, a memory system 300 comprises a nonvolatile memory (NVM) 310 and a memory controller 320. The NVM 310 include a user area 311 and a buffer area 312. The memory controller 320 include an ECC circuit 325 and wear level control logic 326.

As the NVM 310 is continuously used, an ECC error rate for data being read from the NVM may be monitored. A maximum number of bits correctable via the ECC circuit 325 will usually be fixed. Assuming the use of OBP, since the buffer area 312 is iteratively programmed or read, the ECC error rate of the buffer area 312 may increase at a faster rate than that of the user area 311. The memory system 300 may reduce the increase in an ECC error rate of the buffer area 312 by mode changing a part of the user area 311 into the buffer area 312.

Hence, the ECC circuit 325 may provide the wear level control logic 326 with information on an ECC error rate of the nonvolatile memory 310. The wear level control logic 326 may cause execution of a mode change operation in relation to certain memory blocks of the user area 311. For example, when an ECC error rate reaches a given error rate, the wear level control logic 326 may change some memory blocks of the user area 311 into the buffer area 312.

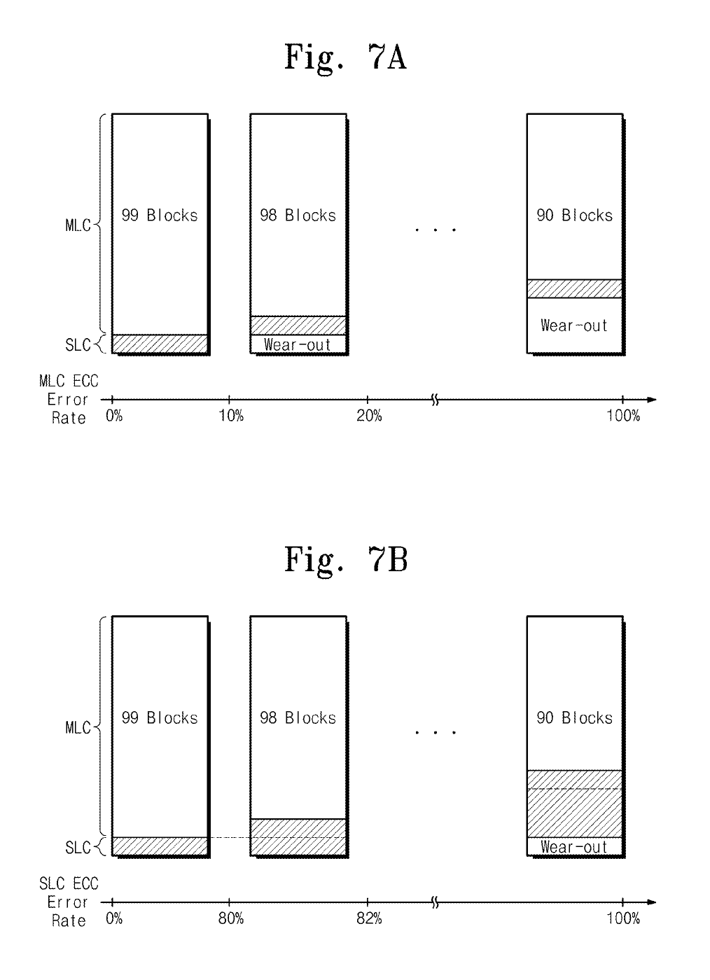

FIGS. 7A and 7B are diagrams describing a mode change operation according to an ECC error rate of the memory system of FIG. 6. FIG. 7A shows a mode change operation according to a variation (%) of an ECC error rate of an MLC user area 311. FIG. 7B shows a mode change operation according to a variation (%) of an ECC error rate of an SLC buffer area 312. For ease of description, it is assumed that the number of correctable ECC error bits of an ECC circuit 325 is 100.

Referring to FIG. 7A, it is assumed that the MLC user area 311 includes 99 memory blocks and the SLC buffer area 312 includes one memory block at a period where an ECC error rate of the MLC user area 311 is between 0% and 10%. In case that the ECC error rate is between 10% and 20%, a part (e.g., one memory block) of memory blocks in the MLC user area 311 may be changed into the SLC buffer area 312. A memory block that was used at the SLC buffer area 312 may be treated as a worn-out memory block. At this time, the MLC user area 311 may include 98 memory blocks. With this manner, in the event that the ECC error rate is between 90% and 100%, 9 memory blocks of the MLC user area 311 may be changed into the SLC buffer area 312. At this time, the MLC user area 311 may include 90 memory blocks.

Referring to FIG. 7B, it is assumed that the MLC user area 311 includes 99 memory blocks and the SLC buffer area 312 includes one memory block at a period where an ECC error rate of the SLC buffer area 312 is between 0% and 80%. Whenever the ECC error rate of the SLC buffer area 312 increases by 2%, one memory block of the MLC user area 311 may be changed into the SLC buffer area 312. Before the ECC error rate reaches 100%, memory blocks that was used at the SLC buffer area 312 may be partially treated as worn-out memory blocks.

7A and 7B illustrate a case wherein ten references are used according to an ECC error rate to change memory blocks of the user area 311 into the buffer area 312. The user area 311 may occupy a space of about 99% at the beginning, yet this allocation may be gradually reduced to about 90%. The space allocated to the user area 311 may be reduced, when the bit error rate for data being read from the buffer area 312 decreases. Thus, the performance of the memory system 300 may be improved.

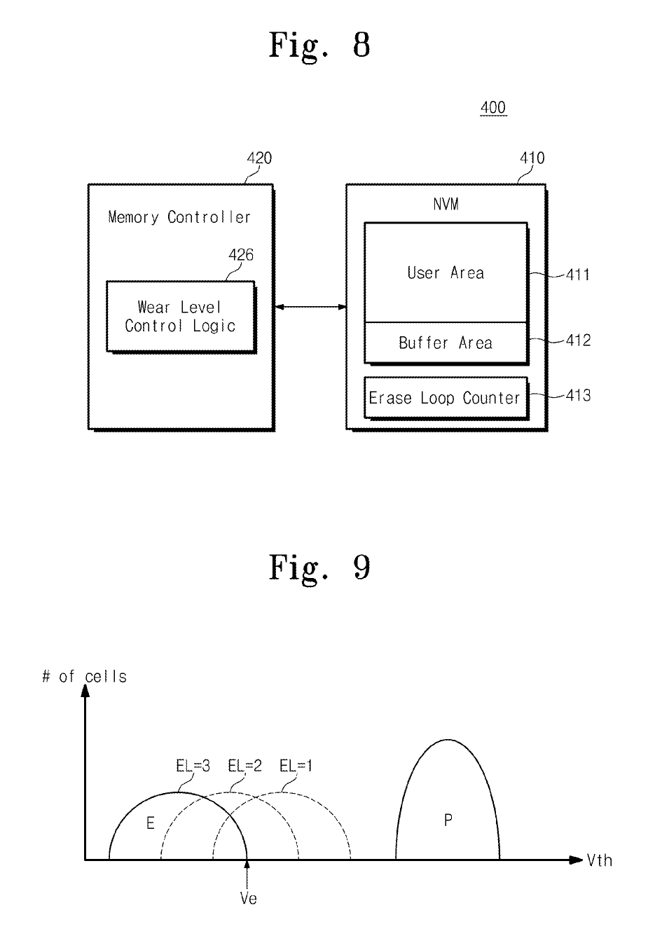

FIG. 8 is a block diagram describing a memory system 400 capable of executing a mode change operation in response to an erase loop count. Referring to FIG. 8, the memory system 400 comprises a nonvolatile memory (NVM) 410 and a memory controller 420. The NVM 410 includes a user area 411 and a buffer area 412. The memory controller 420 includes a wear level control logic 426.

As data is routinely read from and programmed to the NVM 410, the number of erase loops increases. The erase loop count may be used as a wear-level parameter of the nonvolatile memory 410. A maximum erase loop count provide by an erase loop counter 413 may be fixed. Assuming use of OBP, since programing, reading, and erasing on the buffer area 412 is iterative, the wear level of the buffer area 412 will increase at a faster rate than that of the user area 411. The memory system 400 may reduce an increasing rate of an erase loop count of the buffer area 412 by mode changing a part of the user area 411 into the buffer area 412.

The erase loop counter 413 may provide the wear level control logic 426 with information associated with an erase loop count of the nonvolatile memory 410. The wear level control logic 426 may perform a mode change operation on some memory blocks of the user area 411, based on the erase loop count. For example, when the erase loop count reaches a given count, the wear level control logic 426 may change some memory blocks of the user area 411 into the buffer area 412.

FIG. 9 is a conceptual diagram further describing the erase loop count of FIG. 8. Referring to FIG. 9, each memory cell of the NVM 410 may have a program state P or an erase state according to its threshold voltage. The program state may be formed of one or more program states. If an erase voltage is supplied to a memory block, a threshold voltage of a memory cell may be shifted into the erase state. Afterwards, an erase verification voltage Ve may be provided to check whether a threshold voltage of the erased memory cell is shifted into the erase state E. This erase operation may be repeated until all memory cells have the erase state E.

Referring to FIG. 9, since there are memory cells not reaching the erase state E during a first erase loop EL=1, a second erase loop EL=2 may be performed. Since there are memory cells not reaching the erase state E during the first erase loop EL=2, a third erase loop EL=3 may be performed. All memory cells may go to the erase state E at the third erase loop EL=3. At this time, an erase loop counter 413 (refer to FIG. 8) may provide wear level control logic 426 (refer to FIG. 8) with erase loop count information corresponding to 3.

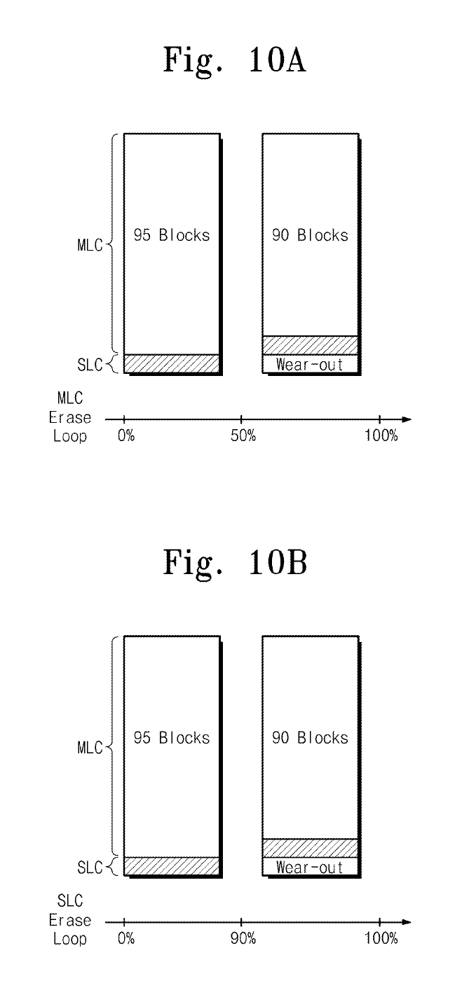

FIGS. 10A and 10B are diagrams further describing a mode change operation according to an erase loop count for the memory system of FIG. 8. FIG. 10A shows a mode change operation according to a variation (%) of an erase loop count of an MLC user area 411, and FIG. 10B shows a mode change operation according to a variation (%) of an erase loop count of an SLC buffer area 412. For ease of description, it is assumed that an erase loop counter 413 is set to have the maximum erase loop count of 10.

Referring to FIG. 10A, at a period where an erase loop count of the MLC user area 411 is between 0% and 50%, the MLC user area 311 may occupy a space of about 95% and the SLC buffer area 412 may occupy a space of about 5%. That is, at a period where an erase loop count of the MLC user area 411 is between 0% and 50%, the MLC user area 411 may include 95 memory blocks and the SLC buffer area 412 may include 5 memory blocks.

In the even that an erase loop count is between 6 and 10, some memory blocks (e.g., 5 memory blocks) of the MLC user area 411 may be changed into the SLC buffer area 412. A memory block that was used at the SLC buffer area 412 may be treated as a worn-out memory block. In this case, the MLC user area 411 may include 90 memory blocks.

Referring to FIG. 10B, at a period where an erase loop count of the SLC buffer area 411 is between 0% and 90%, the MLC user area 411 may occupy a space of about 95% and the SLC buffer area 412 may occupy a space of about 5%. At a period where an erase loop count is between 90% and 100%, some memory blocks (e.g., 5 memory blocks) of the MLC user area 411 may be changed into the SLC buffer area 412. A memory block that was used at the SLC buffer area 412 may be treated as a worn-out memory block. In this case, the MLC user area 411 may include 90 memory blocks.

In FIGS. 10A and 10B, there is illustrated the case that two references are used according to an erase loop count to change memory blocks of the user area 411 into the buffer area 412. The user area 411 may occupy a space of about 95% at the beginning, and a space occupied by the user area 411 may be gradually reduced up to about 90%. A space of the user area 411 may be reduced, while an increasing rate of an erase loop count of the buffer area 412 may decrease. Thus, the performance of the memory system 400 may be improved.

A memory system according to an embodiment of the inventive concept may be applied to various products. The memory system according to an embodiment of the inventive concept may be implemented as electronic devices such as a personal computer, a digital camera, a camcorder, a mobile phone, an MP3 player, a PMP, a PSP, a PDA, and the like and storage devices such as a memory card, an USB memory, a Solid State Drive (SSD), and the like.

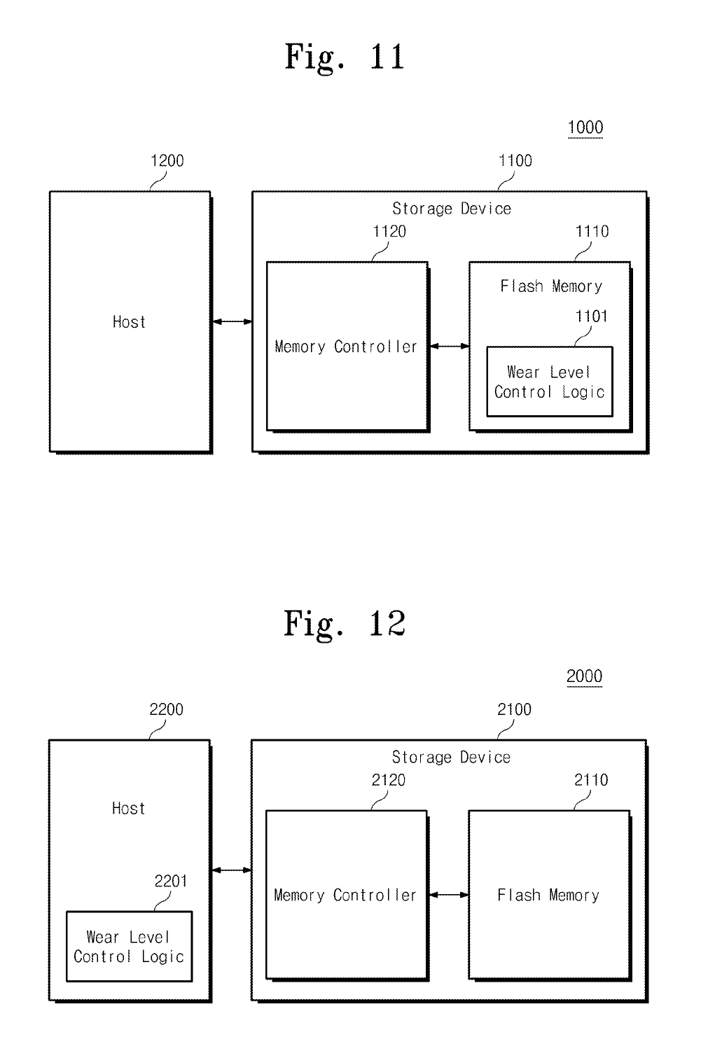

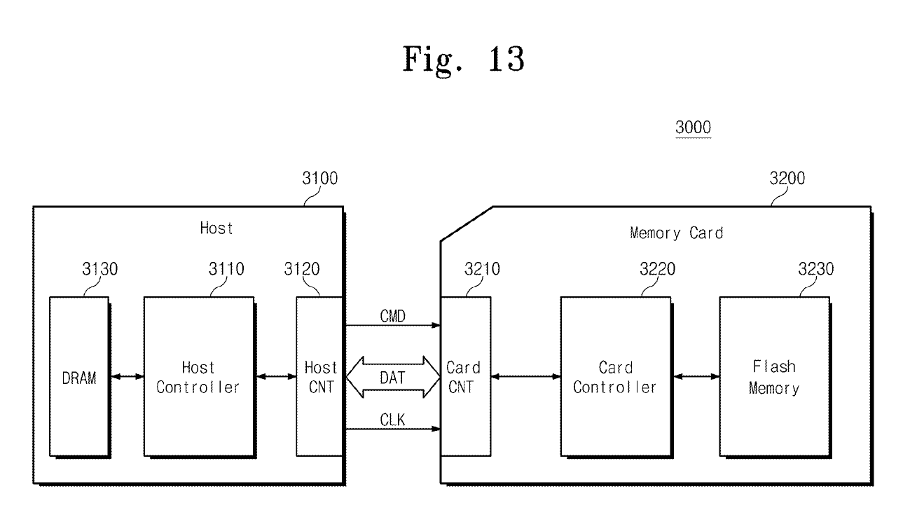

FIGS. 11 and 12 are block diagrams schematically illustrating various applications of a memory system according to an embodiment of the inventive concept. Referring to FIGS. 11 and 12, a memory system may include a storage device and a host. For example, a memory system 1000 in FIG. 11 may include a storage device 1100 and a host 1200, and a memory system 2000 in FIG. 12 may include a storage device 2100 and a host 2200. The storage device 1100 may include a flash memory 1110 and a memory controller 1120, and the storage device 1200 may include a flash memory 2110 and a memory controller 2120.

The storage devices 1100 and 2100 may include a storage medium such as a memory card (e.g., SD, MMC, etc.) or an attachable hand-held storage device (e.g., USB memory, etc.). The storage devices 1100 and 2100 may be connected with the hosts 1200 and 2200, respectively. Each of the storage devices 1100 and 2100 may exchange data with a corresponding host via a host interface. The storage devices 1100 and 2100 may be supplied by powers from the hosts 1200 and 2200 to perform their internal operations.

Referring to FIG. 11, wear level control logic 1101 may be included within the flash memory 1110. Referring to FIG. 12, wear level control logic 2201 may be included within the host 2200. The memory systems 1000 and 2000 may improve the overall system performance by changing a part of a user area of a flash memory into a buffer area using wear level control logic.

FIG. 13 is a block diagram illustrating a memory card system to which a memory system according to an embodiment of the inventive concept is applied. A memory card system 3000 may include a host 3100 and a memory card 3200. The host 3100 may include a host controller 3110, a host connection unit 3120, and a DRAM 3130.

The host 3100 may write data in the memory card 3200 and read data from the memory card 3200. The host controller 3110 may send a command (e.g., a write command), a clock signal CLK generated from a clock generator (not shown) in the host 3100, and data to the memory card 3200 via the host connection unit 3120. The DRAM 3130 may be a main memory of the host 3100.

The memory card 3200 may include a card connection unit 3210, a card controller 3220, and a flash memory 3230. The card controller 3220 may store data in the flash memory 3230 in response to a command input via the card connection unit 3210. The data may be stored in synchronization with a clock signal generated from a clock generator (not shown) in the card controller 3220. The flash memory 3230 may store data transferred from the host 3100. For example, in a case where the host 3100 is a digital camera, the flash memory 3230 may store image data.

The memory card system 3000 in FIG. 13 may include wear level control logic (not shown) that is provided within the host controller 3110, the card controller 3220, or the flash memory 3230. As described above, the inventive concept may improve the overall system performance by changing a part of a user area of a flash memory into a buffer area using wear level control logic.

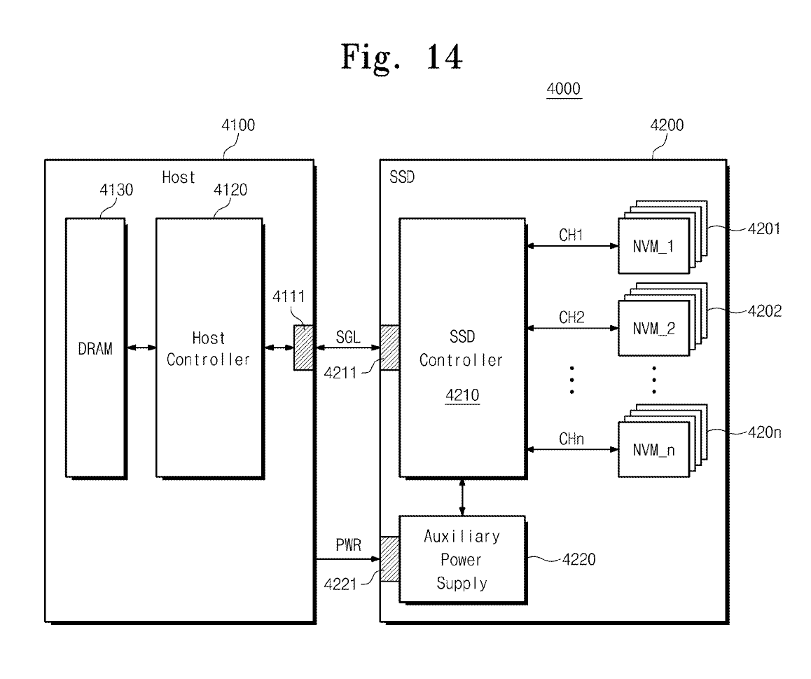

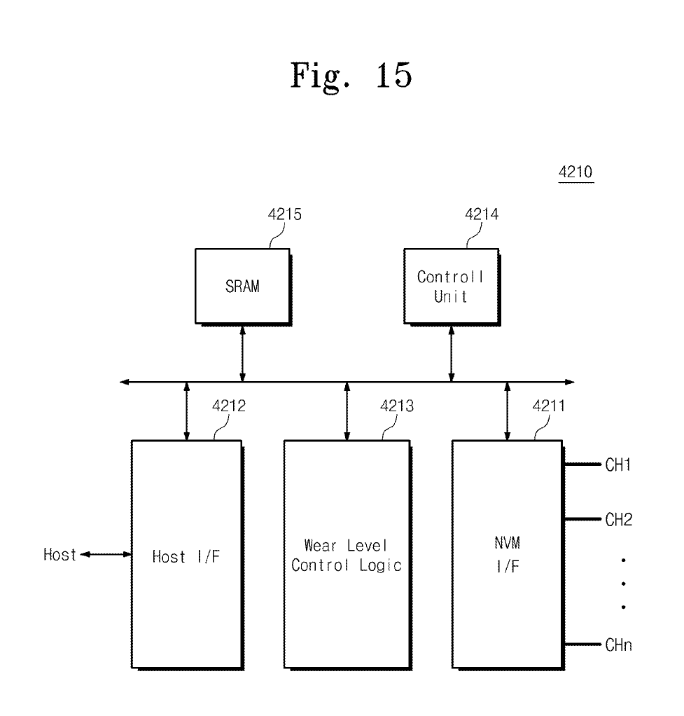

FIG. 14 is a block diagram illustrating a solid state drive system in which a memory system according to the inventive concept is applied. Referring to FIG. 14, a solid state drive (SSD) system 4000 may include a host 4100 and an SSD 4200. The host 4100 may include a host interface 4111, a host controller 4120, and a DRAM 4130.

The host 4100 may write data in the SSD 4200 or read data from the SSD 4200. The host controller 4120 may transfer signals SGL such as a command, an address, a control signal, and the like to the SSD 4200 via the host interface 4111. The DRAM 4130 may be a main memory of the host 4100.

The SSD 4200 may exchange signals SGL with the host 4100 via the host interface 4211, and may be supplied with a power via a power connector 4221. The SSD 4200 may include a plurality of nonvolatile memories 4201 through 420n, an SSD controller 4210, and an auxiliary power supply 4220. Herein, the nonvolatile memories 4201 to 420n may be implemented by not only a flash memory but also PRAM, MRAM, ReRAM, and the like.

The plurality of nonvolatile memories 4201 through 420n may be used as a storage medium of the SSD 4200. The plurality of nonvolatile memories 4201 to 420n may be connected with the SSD controller 4210 via a plurality of channels CH1 to CHn. One channel may be connected with one or more nonvolatile memories. Nonvolatile memories connected with one channel may be connected with the same data bus.

The SSD controller 4210 may exchange signals SGL with the host 4100 via the host interface 4211. Herein, the signals SGL may include a command, an address, data, and the like. The SSD controller 4210 may be configured to write or read out data to or from a corresponding nonvolatile memory according to a command of the host 4100. The SSD controller 4210 will be more fully described with reference to FIG. 15.

The auxiliary power supply 4220 may be connected with the host 4100 via the power connector 4221. The auxiliary power supply 4220 may be charged by a power PWR from the host 4100. The auxiliary power supply 4220 may be placed within the SSD 4200 or outside the SSD 4200. For example, the auxiliary power supply 4220 may be put on a main board to supply an auxiliary power to the SSD 4200.

FIG. 15 is a block diagram schematically illustrating an SSD controller in FIG. 14. Referring to FIG. 15, an SSD controller 4210 may include an NVM interface 4211, a host interface 4212, wear level control logic 4213, a control unit 4214, and an SRAM 4215.

The NVM interface 4211 may scatter data transferred from a main memory of a host 4100 to channels CH1 to CHn, respectively. The NVM interface 4211 may transfer data read from nonvolatile memories 4201 through 420n to the host 4100 via the host interface 4212.

The host interface 4212 may provide an interface with an SSD 4200 according to the protocol of the host 4100. The host interface 4212 may communicate with the host 4100 using USB (Universal Serial Bus), SCSI (Small Computer System Interface), PCI express, ATA, PATA (Parallel ATA), SATA (Serial ATA), SAS (Serial Attached SCSI), etc. The host interface 4212 may perform a disk emulation function which enables the host 4100 to recognize the SSD 4200 as a hard disk drive (HDD).

The wear level control logic 4213 may manage a mode change operation of the nonvolatile memories 4201 through 420n as described above. The control unit 4214 may analyze and process a signal SGL input from the host 4100. The control unit 4214 may control the host 4100 via the host interface 4212 or the nonvolatile memories 4201 through 420n via the NVM interface 4211. The control unit 4214 may control the nonvolatile memories 4201 to 420n using firmware for driving the SSD 4200.

The SRAM 4215 may be used to drive software which efficiently manages the nonvolatile memories 4201 through 420n. The SRAM 4215 may store metadata input from a main memory of the host 4100 or cache data. At a sudden power-off operation, metadata or cache data stored in the SRAM 4215 may be stored in the nonvolatile memories 4201 through 420n using an auxiliary power supply 4220.

Returning to FIG. 14, the SSD system 4000 according to an embodiment of the inventive concept, as described above, may improve the overall system performance by changing a part of a user area of a flash memory into a buffer area using wear level control logic.

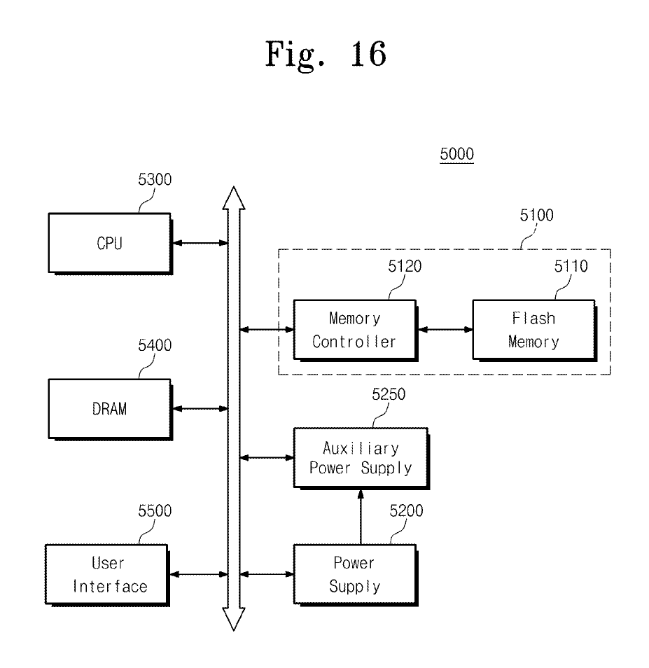

FIG. 16 is a block diagram schematically illustrating an electronic device including a memory system according to an embodiment of the inventive concept. Herein, an electronic device 5000 may be a personal computer or a handheld electronic device such as a notebook computer, a cellular phone, a PDA, a camera, and the like.

The electronic device 5000 may include a memory system 5100, a power supply device 5200, an auxiliary power supply 5250, a CPU 5300, a DRAM 5400, and a user interface 5500. The memory system 5100 may include a flash memory 5110 and a memory controller 5120. The memory system 5100 may be embedded within the electronic device 5000.

As described above, the electronic device 5000 may improve the overall system performance by changing a part of a user area of a flash memory into a buffer area using wear level control logic.

The user device 5100 according to an embodiment of the inventive concept can be applied to a flash memory having a two-dimensional structure as well as a flash memory having a three-dimensional structure.

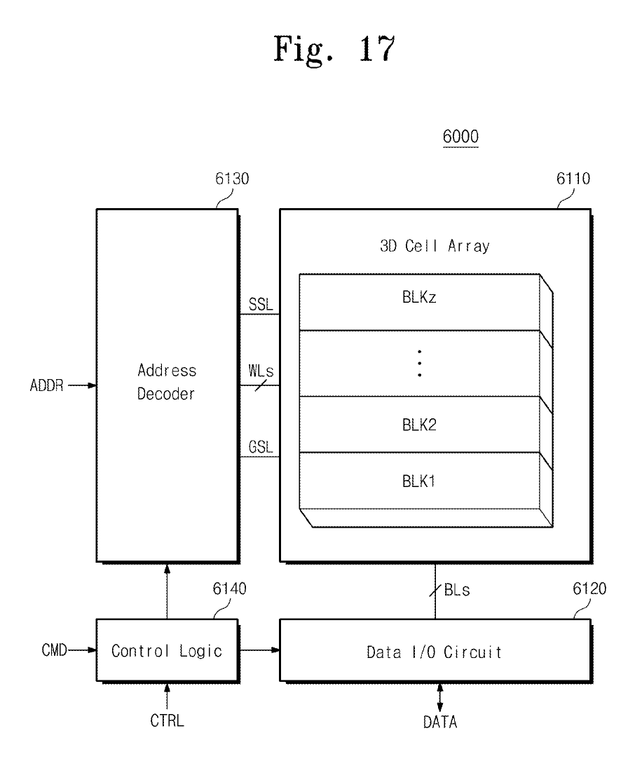

FIG. 17 is a block diagram schematically illustrating a flash memory applied to the inventive concept. Referring to FIG. 17, a flash memory 6000 may include a three-dimensional (3D) cell array 6110, a data input/output circuit 6120, an address decoder 6130, and control logic 6140.

The 3D cell array 6110 may include a plurality of memory blocks BLK1 through BLKz, each of which is formed to have a three-dimensional structure (or, a vertical structure). For a memory block having a two-dimensional (horizontal) structure, memory cells may be formed in a direction horizontal to a substrate. For a memory block having a three-dimensional structure, memory cells may be formed in a direction perpendicular to the substrate. Each memory block may be an erase unit of the flash memory 6000.

The data input/output circuit 6120 may be connected with the 3D cell array 6110 via a plurality of bit lines. The data input/output circuit 6120 may receive data from an external device or may output data read from the 3D cell array 6110 to the external device. The address decoder 6130 may be connected with the 3D cell array 6110 via a plurality of word lines and selection lines GSL and SSL. The address decoder 6130 may select the word lines in response to an address ADDR.

The control logic 6140 may control programming, erasing, reading, and the like of the flash memory 6000. For example, at programming, the control logic 6140 may control the address decoder 6130 such that a program voltage is supplied to a selected word line, and may control the data input/output circuit 6120 such that data is programmed.

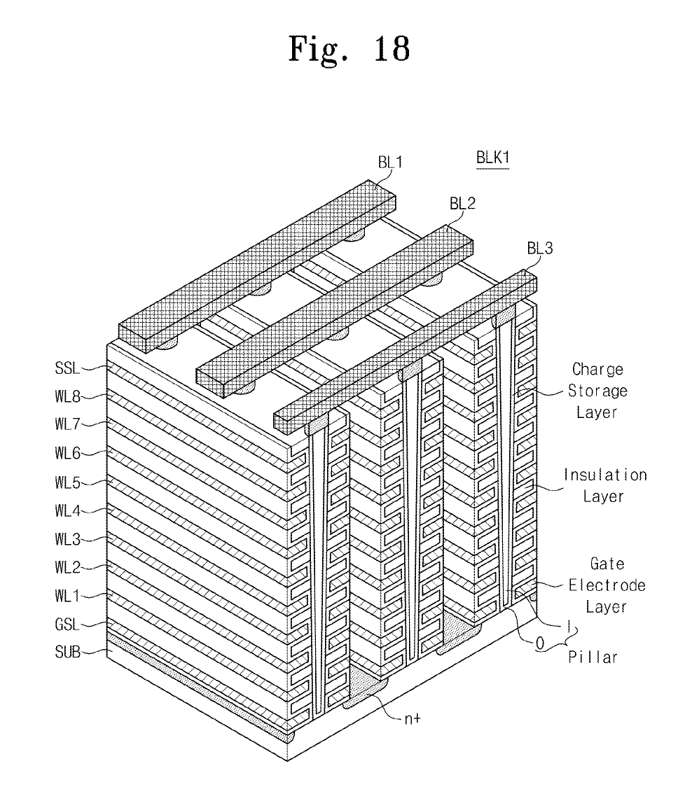

FIG. 18 is a perspective view schematically illustrating a 3D structure of a memory block illustrated in FIG. 17. Referring to FIG. 18, a memory block BLK1 may be formed in a direction perpendicular to a substrate SUB. An n+ doping region may be formed at the substrate SUB. A gate electrode layer and an insulation layer may be deposited on the substrate SUB in turn. A charge storage layer may be formed between the gate electrode layer and the insulation layer.

If the gate electrode layer and the insulation layer are patterned in a vertical direction, a V-shaped pillar may be formed. The pillar may penetrate the gate electrode and insulation layers so as to be connected with the substrate SUB. An outer portion O of the pillar may be formed of a channel semiconductor, and an inner portion thereof may be formed of an insulation material such as silicon oxide.

The gate electrode layer of the memory block BLK1 may be connected with a ground selection line GSL, a plurality of word lines WL1 through WL8, and a string selection line SSL. The pillar of the memory block BLK1 may be connected with a plurality of bit lines BL1 through BL3. In FIG. 18, there is exemplarily illustrated the case that one memory block BLK1 has two selection lines SSL and GSL and eight word lines WL1 to WL8. However, the inventive concept is not limited thereto.

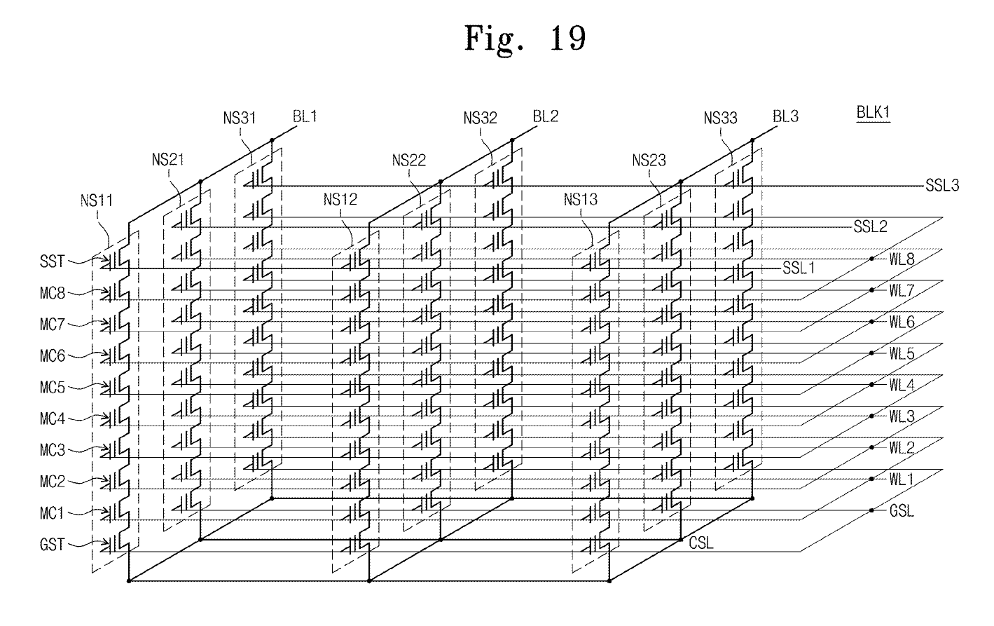

FIG. 19 is a diagram schematically illustrating an equivalent circuit of a memory block illustrated in FIG. 18. Referring to FIG. 19, NAND strings NS11 through NS33 may be connected between bit lines BL1 through BL3 and a common source line CSL. Each NAND string (e.g., NS11) may include a string selection transistor SST, a plurality of memory cells MC1 through MC8, and a ground selection transistor GST.

The string selection transistors SST may be connected with string selection lines SSL1 through SSL3. The memory cells MC1 through MC8 may be connected with corresponding word lines WL1 through WL8, respectively. The ground selection transistors GST may be connected with ground selection line GSL. A string selection transistor SST may be connected with a bit line. And a ground selection transistor GST may be connected with a common source line CSL.

Word lines (e.g., WL1) having the same height may be connected in common, and the string selection lines SSL1 through SSL3 may be separated from one another. At programming of memory cells (constituting a page) connected with a first word line WL1 and included in NAND strings NS11, NS12, and NS13, a first word line WL1 and a first string selection line SSL1 may be selected.

A memory system according to the inventive concept may perform a mode change operation, in which memory blocks of a user area are partially gradually changed into a buffer area, based on wear-level information (e.g., P/E cycle, ECC error rate, erase loop count, etc.). With the inventive concept, the performance of the memory system may be improved by increasing the P/E cycle endurance or reducing an increasing rate of an ECC error rate or an erase loop count.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

What is claimed is:

1. A memory system comprising:
a nonvolatile memory (NVM) including multi-level memory cells (MLC), a first portion of the MLC being designated as a buffer area and operating in a first mode and a second portion of the MLC being designated as a user area and operating in a second mode different from the first mode; and
a memory controller configured to program data to the NVM using on-chip buffered programming, wherein the memory controller comprises wear level control logic configured to determine wear level information for the MLC and change a boundary designating the buffer area from the user area in response to the wear level information.

2. The memory system of claim 1, wherein the wear level information is determined in relation to MLC of the buffer area and includes at least one of program-erase (P/E) cycle information and erase loop count information.

3. The memory system of claim 1, wherein the wear level information is determined in relation to MLC of the user area and includes at least one of program-erase (P/E) cycle information and erase loop count information.

4. The memory system of claim 1, wherein the MLC of the buffer area are each configured according to the first mode to store M bit data, and the MLC of the user area are each configured according to the second mode to store N bit data, where M and N are natural numbers and M is less than N.

5. The memory system of claim 4, wherein the MLC of the buffer area are each configured according to the first mode to store only single bit data.

6. The memory system of claim 4, wherein the memory controller iteratively controls execution of a mode change operation that changes the boundary designating the buffer area from the user area in response to the wear level information.

7. The memory system of claim 6, wherein MLC of the buffer area as operated in the first mode have a program/erase (P/E) cycle endurance greater than the MLC of the user area as operated in the second mode.

8. The memory system of claim 6, wherein upon initialization of the memory system, the memory controller is further configured to set the boundary such that the first portion of the MLC includes a first memory blocks and the second portion of the MLC includes a second memory blocks, and by changing the boundary, at least one of the second memory blocks is re-designated as a first memory block and thereafter operates according to the first mode.

9. The memory system of claim 8, wherein upon initialization of the memory system, the memory controller is further configured to construct a mapping table that indicates the first mode for each of the first memory blocks and indicates the second mode for each of the second memory blocks, and after changing the boundary, the mapping table is updated to indicate the first mode for the least one of the second memory blocks re-designated as a first memory block.

10. The memory system of claim 9, wherein after changing the boundary the memory controller is further configured to update the mapping table to indicate a wear-out state for at least one of the first memory blocks.

11. The memory system of claim 1, wherein the NVM is flash memory.

12. A memory system comprising:
a nonvolatile memory (NVM) including multi-level memory cells (MLC), a first portion of the MLC being designated as a buffer area and operating in a first mode and a second portion of the MLC being designated as a user area and operating in a second mode different from the first mode; and
a memory controller configured to program data to the NVM using on-chip buffered programming, and comprising an error correction code circuit (ECC) that detects and corrects bit errors in data read from the NVM and provides ECC error rate information, and wear level control logic configured to determine wear level information for the MLC in relation to the ECC error rate information and change a boundary designating the buffer area from the user area in response to the ECC error rate information.

13. The memory system of claim 12, wherein the ECC error rate information is determined in relation to at least one of MLC in the buffer area and MLC of the user area.

14. The memory system of claim 12, wherein the MLC of the buffer area are each configured according to the first mode to store M bit data, and the MLC of the user area are each configured according to the second mode to store N bit data, where M and N are natural numbers and M is less than N.

15. The memory system of claim 14, wherein MLC of the buffer area as operated in the first mode have a program/erase (P/E) cycle endurance greater than the MLC of the user area as operated in the second mode.

16. A method of operating a memory system including a nonvolatile memory (NVM) of multi-level memory cells (MLC) and a memory controller, the method comprising:
upon initialization of the memory system, using the memory controller to designate a first portion of the MLC as a buffer area operating in a first mode and a second portion of the MLC as a user area operating in a second mode;
programming input data to the NVM under the control of the memory controller using on-chip buffered programming that always first programs the input data to the buffer area and then moves the input data from the buffer area to the user area; and
determining wear level information for the MLC and changing a boundary designating the buffer area from the user area in response to the wear level information.

17. The method of claim 16, wherein the wear level information is determined for the MLC in relation to least one of program-erase (P/E) cycle information, error rate information for data read from the MLC, and erase loop count information.

18. The method of claim 16, wherein the MLC of the buffer area store M bit data and the MLC of the user area store N bit data, where M and N are natural numbers and M is less than N.

19. The method of claim 16, wherein the first mode stores only a single data bit in the MLC of the buffer area and the second mode stores at least two data bits in the MLC of the user area.

20. The method of claim 19, wherein MLC of the buffer area have a program/erase (P/E) cycle endurance greater than the MLC of the user area.
